(19) United States
(12) Patent Application Publication
(10) Pub. No.: US 2007/0296996 A1
(43) Pub. Date: Dec. 27, 2007

(54) Printing apparatus

(75) Inventor: Kouichi Hiromachi, Tokyo (JP)

Correspondence Address: TAKEUCHI & KUBOTERA, LLP, SUITE 202, 200 DAINGERFIELD ROAD, ALEXANDRIA, VA, 22314, US

(73) Assignee: Oki Data Corporation

(21) Appl. No.: 11/812,722

(22) Filed: Jun. 21, 2007

(30) Foreign Application Priority Data
Jun. 26, 2006 (JP) 2006-175265

(51) Int. Cl. G06F 3/12

(52) U.S. Cl. 358/1.13

(57) ABSTRACT

The printing apparatus includes a language determining unit for determining whether print data is described in a first description language or a second description language; a first language conversion unit for converting the print data described in the second description language to the print data described in the first description language when the language determining unit determines that the print data is described in the second description language; and a first print control unit for analyzing the print data described in the first description language and printing on a recording medium.

### BACKGROUND OF THE INVENTION

1. Field of the Invention

The present invention relates to a printing apparatus for receiving print data and printing on a sheet according to a printer description language.

2. Description of Related Art

When a conventional printing apparatus prints print data received from a host device such as a personal computer, the printing apparatus first analyzes a print description language received as the print data, i.e. a page description language (PDL). Then, the printing apparatus edits a page, and deploys the print data to a print image, thereby printing on a sheet (refer to Patent Reference).

FIG. 2 is a block diagram showing a conventional printing apparatus. As shown in FIG. 2, a printer 102 as a printing apparatus is connected to a host device 101 such as a personal computer via a network or the like, so that the host device 101 sends print data to the printer 102. The printer 102 has a receiver 111 to receive the print data from the host device 101; an analyzer 112 to analyze a page description language received by the receiver 111 as the print data; an editing unit 113 for editing a page; a deploying unit 114 to deploy the print data thus edited to a print image; and a printing unit 115 to print the print image thus deployed.

### Patent Reference Japanese Patent Publication No. 05-124295

In the above-described conventional printing device, however, in order to print an image based on several page description languages, it is necessary to provide a plurality of analyzers 112, editing units 113, and deploying units 114. Accordingly, a size of a program tends to increase, thereby requiring a memory to have a large size.

FIG. 3 is a block diagram showing another conventional printing apparatus. As shown in FIG. 3, the printer 102 is adopted to be capable of printing an image based on two page description languages. To this end, the printer 102 needs to have two analyzers, i.e., a first analyzer 112a and a second analyzer 112b; two editing units, i.e., a first editing unit 113a and a second editing unit 113b; and two deploying units, i.e., a first deploying unit 114a and a second deploying unit 114b.

In view of the problems described above, an object of the invention is to provide a printing apparatus capable of solving the problems of the conventional printing apparatus.

Further objects and advantages of the invention will be apparent from the following description of the invention.

### SUMMARY OF THE INVENTION

In order to attain the objects described above, according to the present invention, a printing apparatus deploys print data described in a first printer description language to a print image for printing. Further, the printing apparatus converts print data described in a second printer description language to print data described in the first print description language, and deploys the print data to a print image for printing. Accordingly, it is possible to use a program with a small size and share an editing unit and a deploying unit, thereby reducing memory source consumption.

According to the present invention, the printing apparatus is capable of processing at least a first printer description language and a second printer description language. The printing apparatus includes a print control unit for deploying print data described in the first printer description language to a print image; and a language conversion unit for converting print data described in the second printer description language to print data described in the first printer description language. After the language conversion unit converts the print data described in the second printer description language into the print data described in the first printer description language, the print control unit deploys the print data to a print image for printing.

In the invention, the printing apparatus deploys the print data described in the first printer description language to the print image for printing. Further, the printing apparatus converts the print data described in the second printer description language to the print data described in the first print description language, and deploys the print data to the print image for printing. Accordingly, it is possible to use a program with a small size and share an editing unit and a deploying unit, thereby reducing memory source consumption.

### BRIEF DESCRIPTION OF THE DRAWINGS

FIG. 1 is a block diagram showing a configuration of a printer according to a first embodiment of the present invention;

FIG. 2 is a block diagram showing a configuration of a conventional printing apparatus;

FIG. 3 is a block diagram showing a configuration of another conventional printing apparatus;

FIG. 4 is a flow chart showing an operation of the printer according to the first embodiment of the present invention;

FIG. 5 is a partial block diagram showing a detailed configuration of the printer according to the first embodiment of the present invention;

FIG. 6 is a flow chart showing an operation of a PAGES (Page Printer Advanced Graphics Escape Set) language analyzing unit and a PCL (Printer Control Language) language conversion unit according to the first embodiment of the present invention;

FIG. 7 is a block diagram showing a configuration of a printer according to a second embodiment of the present invention;

FIG. 8 is a schematic view showing a menu unit according to the second embodiment of the present invention;

FIG. 9 is a flow chart showing an operation of the printer according to the second embodiment of the present invention;

FIG. 10 is a partial block diagram showing a detailed configuration of the printer according to the second embodiment of the present invention; and

FIG. 11 is a flow chart showing an operation of a PAGES language analyzing unit, a PCL language conversion unit, a PS (Post Script) language conversion unit, and a conversion language determining unit according to the second embodiment of the present invention.

### DESCRIPTION OF THE PREFERRED EMBODIMENTS

Hereunder, embodiments of the present invention will be explained with reference to the accompanying drawings.

### First Embodiment

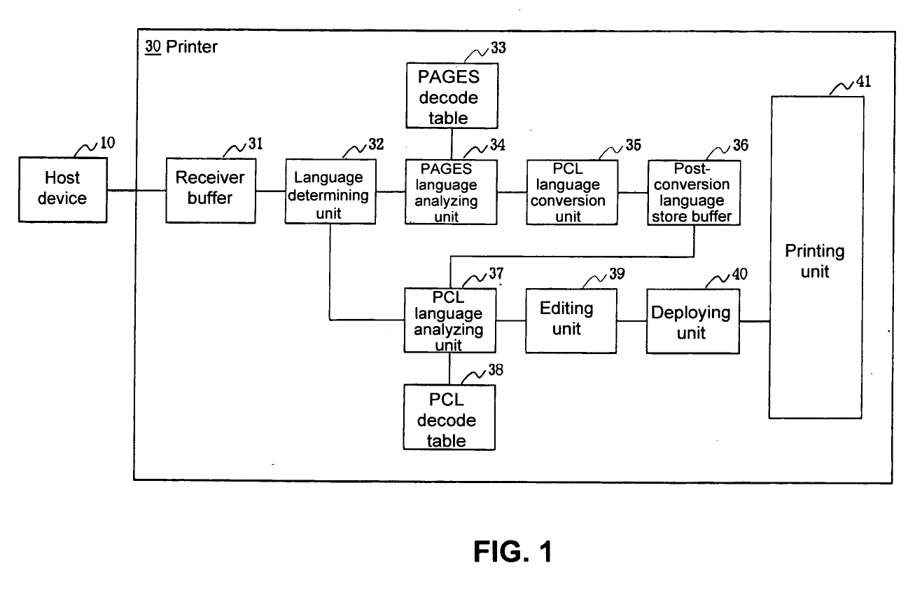

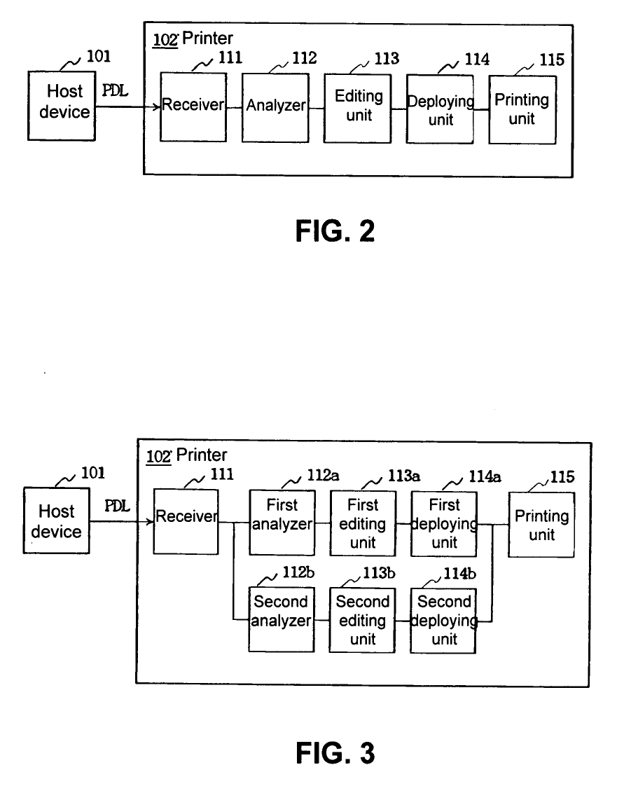

FIG. 1 is a block diagram showing a configuration of a printer 30 according to a first embodiment of the present invention. As shown in FIG. 1, a host device 10 is provided for supplying print data to the printer 30 as a printing apparatus. The host device 10 is a computer having a processing unit such as a CPU and an MPU; a memory unit such as a magnetic disc and a semiconductor memory; an input unit such as a keyboard, a mouse, and a touch panel; a display unit such as a CRT and a liquid display; and a communication interface.

In the embodiment, the host device may include a device such as, for example, a server, a Personal Digital Assistant (PDA), an electronic notebook, and a game machine, as far as the device is capable of supplying print data to the printer 30. In the following description, a personal computer is described as the host device 10.

In the embodiment, the printer 30 has a printing unit 41 as a printer engine, and is connected to the host device 10 via a communication system. Further, the printer 30 receives the print data generated by the host device 10, and prints on a sheet as a printing medium according to the print data. The printing unit 41 may include a device capable of printing the print data on a sheet such as, for example, a device of inkjet type, a device of electro-photographic type, and a device of thermal transfer type. Further, the printing unit 41 may be a color printing device or a monochrome printing device.

In the embodiment, the communication system for connecting between the host device 10 and the printer 30 may include a cable such as a USB (Universal Serial Bus) cable and an IEEE1284 cable; a network such as intranet, LAN (Local Area Network), and WAN (Wide Area Network); an IP (internet Protocol) network such as internet; and other types of communication systems.

In the embodiment, the printer 30 includes a processing unit such as a CPU and an MPU; a memory unit such as a magnetic disc and a semiconductor memory; and a communication interface. The printer 31 deploys the print data received from the host device 10 to a print image, so that the printing unit 41 prints the print image on the sheet. Further, the printer 30 includes a receiver buffer 31; a language determining unit 32; a PAGES (Page Printer Advanced Graphics Escape Set) decode table 33; a PAGES language analyzing unit 34; a PCL (Printer Control Language) language conversion unit 35 as a language conversion unit; a post-conversion language store buffer 36; a PCL language analyzing unit 37; a PCL decode table 38; an editing unit 39; and a deploying unit 40.

In the embodiment, the receiver buffer 31 receives the print data from the host device 10. The language determining unit 32 determines a printer description language, i.e., a page description language (PDL), from the print data retrieved from the receiver buffer 31, and determines whether the page description language is described in a PCL format as a first page description language or a PAGES format as a second page description language. When the page description language is described in the PCL format, the language determining unit 32 sends an address of the receiver buffer 31 to the PCL language analyzing unit 37. When the page description language is described in the PAGES format, the language determining unit 32 sends the address of the receiver buffer 31 to the PAGES language analyzing unit 34.

In the embodiment, the PAGES language analyzing unit 34 analyzes data obtained from the receiver buffer 31 according to the PAGES decode table 33. The PCL language conversion unit 35 converts the data in the format PAGES into the PCL format based on a result analyzed by the PAGES language analyzing unit 34, and stores the data thus converted in the post-conversion language store buffer 36.

In the embodiment, the PCL language analyzing unit 37 analyzes the data in the PCL format obtained from the receiver buffer 31 or the post-conversion language store buffer 36, according to the PCL decode table 38. The editing unit 39 the converts the data analyzed by the PCL language analyzing unit 37 to an intermediate code. The deploying unit 40 deploys the intermediate code to the print image. In this case, the editing unit 39 and the deploying unit 40 function as a print control unit. The printing unit 41 prints the print image on the sheet.

An operation of the printer 30 having the above-described configuration will be explained next. First, an operation of the printer 30 as a whole when the printer 30 receives the print data from the host device 10 will be explained.

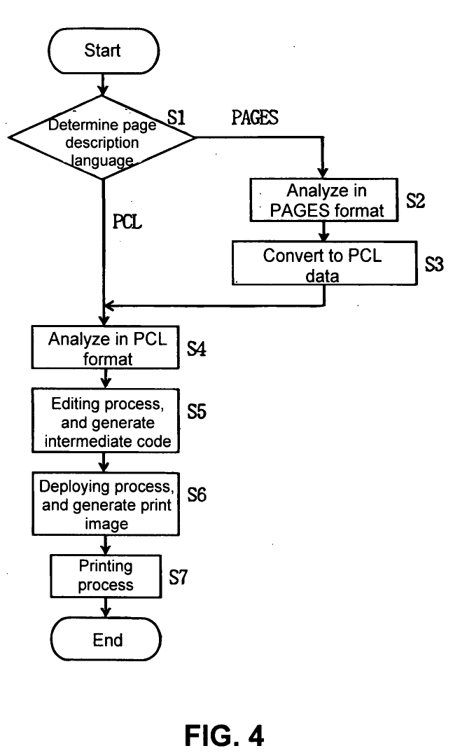

FIG. 4 is a flow chart showing the operation of the printer 30 according to the first embodiment of the present invention. First, the print data received from the host device 10 is written in the receiver buffer 31. Then, the language determining unit 32 analyzes the print data written in the receiver buffer 31, and determines the page description language.

When the page description language is the PAGES format, the language determining unit 32 sends the address of the receiver buffer 31, in which the print data is written, to the PAGES language analyzing unit 34. Then, the PAGES language analyzing unit 34 analyzes the data obtained from the receiver buffer 31 according to the PAGES decode table 33. Then, the PCL language conversion unit 35 converts the PAGES format to the PCL format per one command based on the result analyzed by the PAGES language analyzing unit 34, and stores the data thus converted in the post-conversion language store buffer 36. Then, the PCL language conversion unit 35 sends the address of the post-conversion language store buffer 36 to the PCL language analyzing unit 37 as the print data.

The language determining unit 32 analyzes the print data written in the receiver buffer 31 to determine the page description language. When the page description language is the PCL format, the language determining unit 32 sends the address of the receiver buffer 31, in which the print data is written, to the PCL language analyzing unit 37.

Then, while retrieving the data from the address of the buffer (the receiver buffer 31 or the post-conversion language store buffer 36) sent from the language determining unit 32, the PCL language analyzing unit 37 successively analyzes the data referring to the PCL decode table 33, and directs the editing unit 39 to edit a page. Upon receiving the direction from the PCL language analyzing unit 37, the editing unit 39 starts editing the page, and generates the intermediate code constituting the page. Once the editing unit 39 completes the editing for one page, the editing unit 39 directs the deploying unit 40 to deploy the page.

Thereafter, the deploying unit 40 reads the intermediate code and deploys the intermediate code to the print image. Once the deploying unit 40 completes generation of the print image, the deploying unit 40 sends the print image to the printing unit 41. Then, the printing unit 41 performs a printing process, and prints the print image on the sheet.

The flow chart shown in FIG. 4 will be explained next. In Step S1, the language determining unit 32 determines the page description language. When the page description language is the PAGES format, the process proceeds to Step S2. When the page description language is the PCL format, the process proceeds to Step S4.

In Step S2, the PAGES language analyzing unit 34 analyzes the data in the PAGES format. In Step S3, the PAGES format is converted to the PCL format. In Step S4, the PCL language analyzing unit 37 analyzes the data in the PCL format. In Step S5, the editing unit 39 performs the editing process, and generates the intermediate code. In Step S6, the deploying unit 40 performs the deploying process, and generates the print image. In Step S7, the printing process is performed, thereby completing the process.

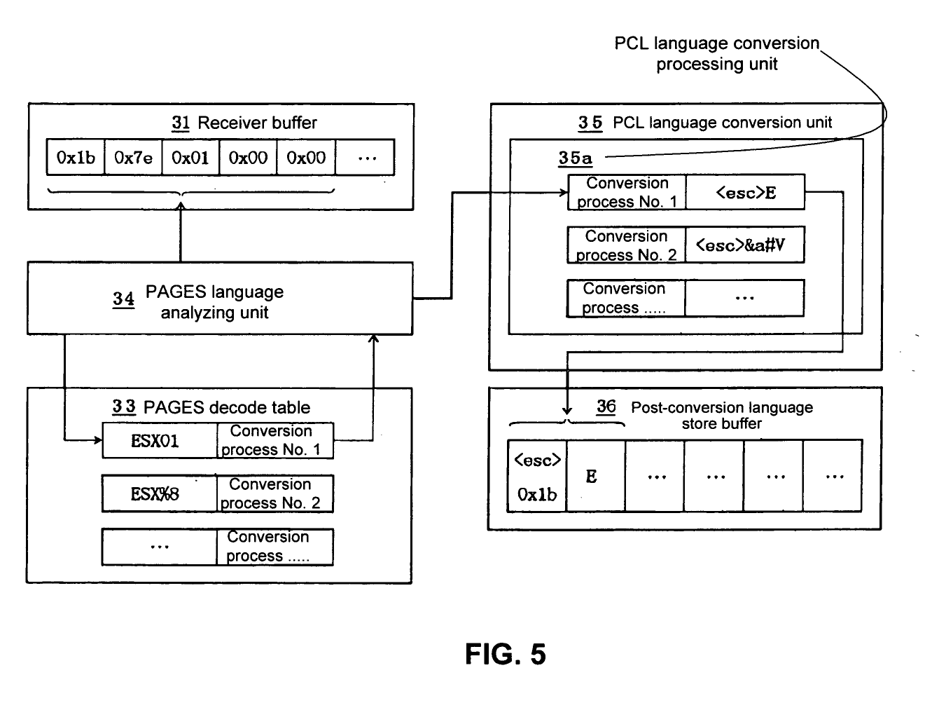

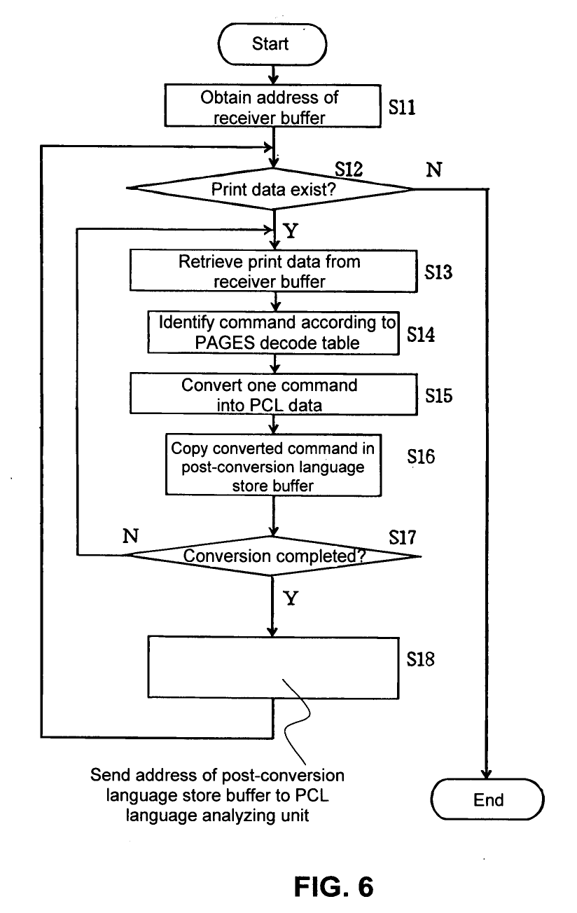

An operation of the PAGES language analyzing unit 34 and the PCL language conversion unit 35 will be explained next. FIG. 5 is a partial block diagram showing a detailed configuration of the printer according to the first embodiment of the present invention. FIG. 6 is a flow chart showing the operation of the PAGES language analyzing unit 34 and the PCL language conversion unit 35 according to the first embodiment of the present invention.

When the PAGES language analyzing unit 34 obtains the address of the receiver buffer 31 sent from the host device, i.e., the language determining unit 32, the PAGES language analyzing unit 34 confirms whether the print data exists in the receiver buffer 31. When the print data exists, the PAGES language analyzing unit 34 subsequently reads the print data from the receiver buffer 31, and identifies one command according to the PAGES decode table 33.

For example, as shown in FIG. 5, the PAGES language analyzing unit 34 obtains “0x1b, 0x7e, 0x01, 0x00, 0x00 (representing a reset command in the PAGES format and to be denoted as “ESX01” in a PAGES command system.)” from the receiver buffer 31 as the print data. According to the PAGES decode table 33, the PAGES language analyzing unit 34 identifies “ESX01” as a command for performing a conversion process No. 1.

In order to convert the command thud identified to the PCL data, the PAGES language analyzing unit 34 directs the PCL language conversion unit 35 to perform the conversion process No. 1. Accordingly, the PCL language conversion processing unit 35 converts the command to the PCL data through the conversion process NO. 1 directed by the PAGES language analyzing unit 34.

As shown in FIG. 5, the PCL language conversion unit 35 has a PCL language conversion processing unit 35a. When the PCL language conversion unit 35 is directed to perform the converting process No. 1, the PCL language conversion unit 35 calls the conversion process No. 1 from the PCL language conversion processing unit 35a. In the conversion process No. 1, “<esc>E” (representing the reset command in the PCL format, where <esc> represents “0x1b” in hexadecimal) is written in the post-conversion language store buffer 36, and the PCL language conversion unit 35 copies the command thus converted in the post-conversion language buffer 36.

For example, when the command is “ESXxx5xx” for specifying five copies, an input parameter is set five in a conversion process No. 10. Accordingly, the command is converted to a copy command in the PCL format such as “ESC&x5x”. When the command is a raster data 100 [byte] command such as “ESXx100xx01057E . . . ”, “100” and “the address of the received data in which the raster data is stored” become input parameters in a conversion process No. 15. The PCL language conversion processing unit 35a also performs a process of converting data in a PAGES coordinate system into data in a PCL coordinate system.

Then, it is determined whether the conversion is completed. When the conversion is completed, the PCL language conversion unit 35 sends the address of the post-conversion language store buffer 36 to the PCL language analyzing unit 37. The PCL language conversion unit 35 repeats the above-described process until all of the print data in the receiver buffer 31 is processed. When all of the print data is processed, the process is completed.

The flow chart shown in FIG. 6 will be explained next. In Step S11, the PAGES language analyzing unit 34 obtains the address of the receiver buffer 31. In Step S12, it is determined whether the print data exists. When the print data exists, the process proceeds to Step S13. When the print data does not exist, the process is completed.

In Step S13, the print data is read from the receiver buffer 31. In Step S14, the command is identified from the PAGES decode table 33. In Step S15, one command is converted into the PCL data. In Step S16, the command thus converted is copied in the post-conversion language store buffer 36.

In Step 17, it is determined whether the conversion is completed. When the conversion is completed, the process proceeds to Step S18. When the conversion is not completed, the process returns to Step S13. In Step S18, the address of the post-conversion language store buffer 36 is sent to the PCL language analyzing unit 37, and the process returns to Step S13.

As described above, the printer 30 converts the print data described in the PAGES format to the print data described in the PCL format, and sends the data thus converted into the PCL format to the PCL language analyzing unit 37 as if the PCL language analyzing unit 37 receives the data from the host device 10. Accordingly, the printer 30 can share the editing unit 39 and the deploying unit 40, thereby making the printer 30 a simple configuration.

In the embodiment, it is not necessary to provide the printer 30 with an additional editing unit or an additional deploying unit. Accordingly, as opposed to a conventional printing apparatus in which it is necessary to provide an additional editing unit and an additional deploying unit, when a different page description language is added to the printer 30, it is necessary to understand only minimum necessary architecture of the printer 30, thereby reducing the number of development processes.

Further, when the architecture of the printer 30 is changed, the PCL language conversion unit 35 is not affected to a large extent. Accordingly, when maintenance work is needed, it is possible to reduce the number of processes.

As described above, in the embodiment, the printer 30 converts the data written in the PAGES format as the second printer description language or the second page description language into the PCL format as the first printer description language or the first page description language. Then, the printer 30 edits and deploys the data into the print image, thereby printing. Accordingly, it is possible to use a program with a small size and share the editing unit 39 and the deploying unit 40, thereby reducing memory.

### Second Embodiment

A second embodiment of the present invention will be described next. Components in the second embodiment similar to those in the first embodiment are designated by the same reference numerals, and explanations thereof are omitted. The components in the second embodiment similar to those in the first embodiment provide effects similar to those in the first embodiment, and explanations thereof are omitted.

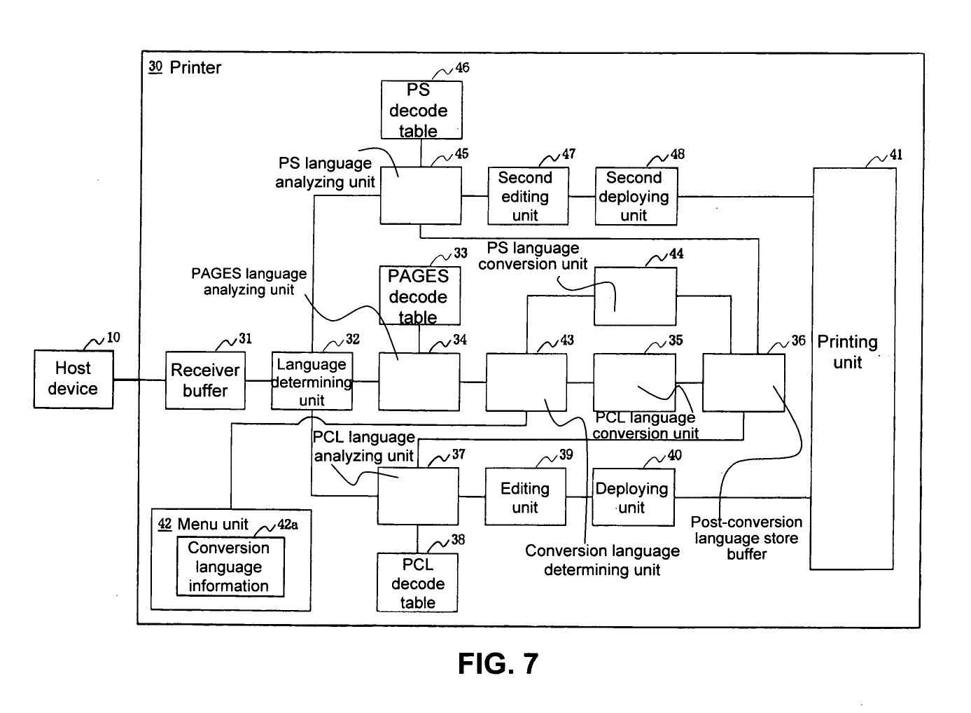

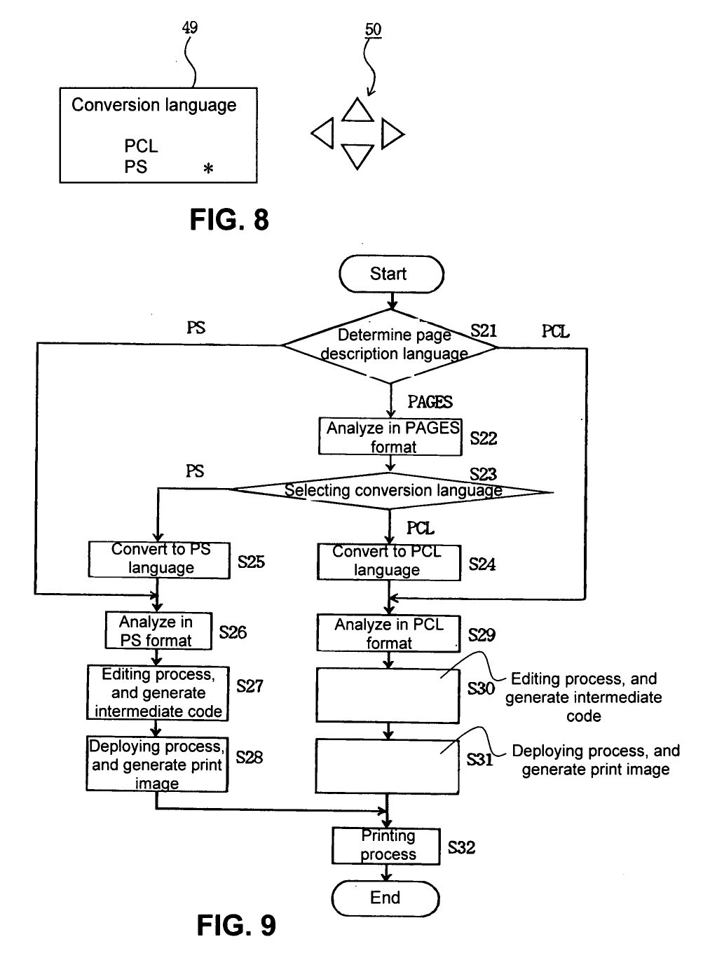

FIG. 7 is a block diagram showing a configuration of the printer 30 according to the second embodiment of the present invention. FIG. 8 is a schematic view showing a menu unit 42 according to the second embodiment of the present invention.

As shown in FIG. 7, the printer 30 includes the menu unit 42; a conversion language determining unit 43; a PS (Post Script) language conversion unit 44 as a second language conversion unit; a PS decode table 46; a second editing unit 47; and a second deploying unit 48.

In the embodiment, the PS language conversion unit 44 converts the PAGES data into the PS data based on a result analyzed by the PAGES language analyzing unit 34, and stores the data thus converted in the post-conversion language store buffer 36. Further, the PS language analyzing unit 45 analyzes the PS data as a third printer description language or a third page description language obtained form the receiver buffer 31 or the post-conversion language store buffer 36.

In the embodiment, the second editing unit 47 converts the PS data analyzed by the PS language analyzing unit 45 to an intermediate code. The second deploying unit 48 deploys the intermediate code into the print image, and sends the print image to the printing unit 41. In this case, the second editing unit 47 and the second deploying unit 48 work as a second print control unit.

In the embodiment, the menu unit 42 has conversion language information 42a. The conversion language determining unit 43 selects a conversion language according to the conversion language information 42a, so that the conversion language determining unit 43 determines to call the PCL language conversion unit 35 or the PS language conversion unit 44. As shown in FIG. 8, the menu unit 42 has a menu display unit 49 for displaying the conversion language and an operation unit 50. Other components are similar to those in the first embodiment, and explanations thereof are omitted.

An operation of the printer 30 according to the second embodiment will be described below. First, an operation of the printer 30 as a whole when the printer 30 receives the print data from the host device 10 will be explained. FIG. 9 is a flow chart showing the operation of the printer 30 according to the second embodiment of the present invention.

First, the print data received from the host device 10 is written in the receiver buffer 31. Then, the language determining unit 32 analyzes the print data written in the receiver buffer 31, and determines the page description language.

When the page description language is the PAGES format, the language determining unit 32 sends the address of the receiver buffer 31, in which the print data is written, to the PAGES language analyzing unit 34. The PAGES language analyzing unit 34 analyzes the data obtained from the receiver buffer 31 according to the PAGES decode table 33. Then, the conversion language determining unit 43 obtains the conversion language information 42a from the menu unit 42, and selects the conversion language according to the conversion language information 42a.

When the conversion language set in the conversion language information 42a is the PCL format, the PCL language conversion unit 35 converts the language in the PAGES format into the PCL format per one command according to the result analyzed by the PAGES language analyzing unit 34, and stores the data thus converted in the post-conversion language store buffer 36. Then, the PCL language conversion unit 35 sends the address of the post-conversion language store buffer 36 to the PCL language analyzing unit 37 as the print data.

When the conversion language set in the conversion language information 42a is the PS format, the PS language conversion unit 44 converts the language in the PAGES format into the PS format per one command based on the result analyzed by the PAGES language analyzing unit 34, and stores the data thus converted in the post-conversion language store buffer 36. Then, the PS language conversion unit 44 sends the address of the post-conversion language store buffer 36 to the PS language analyzing unit 45.

Afterward, the PS language analyzing unit 45 subsequently analyzes the data described in the PS format, i.e., the page description language obtained from the receiver buffer 31 or the post-conversion language store buffer 36, and directs the second editing unit 48 to edit the page. Accordingly, the second editing unit 47 starts editing the page upon receiving the direction from the PS language analyzing unit 45, and generates the intermediate code constituting the page. When the second editing unit 47 completes the editing for one page, the second editing unit 47 directs the second deploying unit 48 to deploy the page.

Thereafter, the second deploying unit 48 retrieves the intermediate code and deploys the data into the print image. When the second deploying unit 48 completes generation of the print image, the second deploying unit 48 sends the print image to the printing unit 41. Accordingly, the printing unit 41 performs the printing process, and prints the print image on the sheet.

The PCL language analyzing unit 37 subsequently analyzes the data described in the PCL format, i.e., the page description language obtained from the receiver buffer 31 or the post-conversion language store buffer 36, according to the PCL decode table 38, and directs the editing unit 39 to edit the page. Accordingly, the editing unit 39 starts editing the page upon receiving the direction from the PCL language analyzing unit 37, and generates the intermediate code constituting the page. When the editing unit 39 completes the editing for one page, the editing unit 39 directs the deploying unit 40 to deploy the page.

The deploying unit 40 retrieves the intermediate code and deploys the data into the print image. When the deploying unit 40 completes generation of the print image, the deploying unit 40 sends the print image to the printing unit 41. Accordingly, the printing unit 41 performs the printing process, and prints the print image on the sheet. Other operations are similar to those in the first embodiment, and explanations thereof are omitted.

The flow chart shown in FIG. 9 will be explained next. In Step S21, the language determining unit 32 determines the page description language. When the page description language is the PAGES format, the process proceeds to Step S22. When the page description language is the PS format, the process proceeds to Step S26. When the page description language is the PCL format, the process proceeds to Step S29.

In Step S22, the PAGES language analyzing unit 34 analyzes the print data in the PAGES format. In Step S23, the conversion language determining unit 43 selects the conversion language. When the conversion language is the PCL format, the process proceeds to Step S24. When the conversion language is the PS format, the process proceeds to Step S25.

In Step S24, the PCL language conversion unit 35 converts the data in the PAGES format to the PCL format. In Step S25, the PS language conversion unit 44 converts the data in the PAGES format to the PS format. In Step S26, the PS language analyzing unit 45 analyzes the data in the PS format.

In Step S27, the second editing unit 47 performs the editing process, and generates the intermediate code. In Step S28, the second deploying unit 48 performs the deploying process, and generates the print image.

In Step S29, the PCL language analyzing unit 37 analyzes the data in the PCL format. In Step S30, the editing unit 39 performs the editing process, and generates the intermediate code. In Step S31, the deploying unit 40 performs the developing process, and generates the print image. In Step S32, the printing unit 41 performs the printing process, and completes the process.

An operation of the PAGES language analyzing unit 34, the PCL language conversion unit 35, the PS language conversion unit 44, and the conversion language determining unit 43 will be described below.

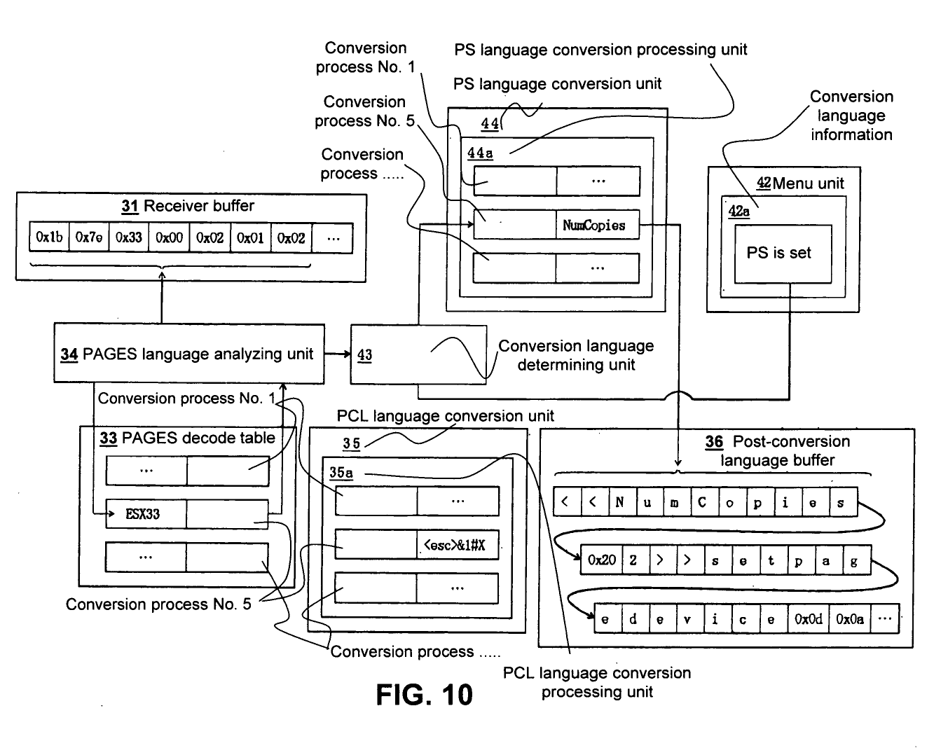

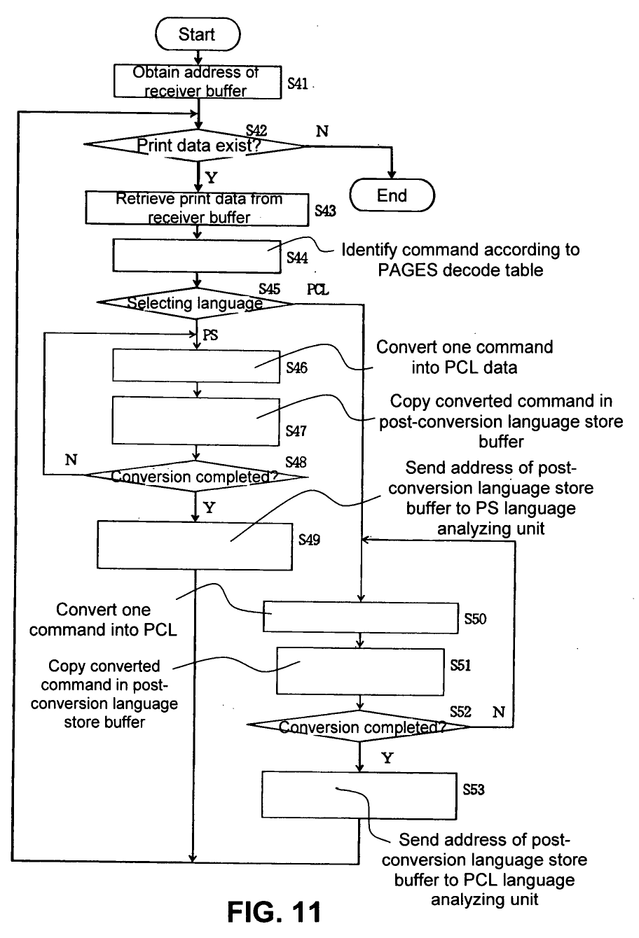

FIG. 10 is a partial block diagram showing a detailed configuration of the printer 30 according to the second embodiment of the present invention. FIG. 11 is a flow chart showing the operation of the PAGES language analyzing unit 34, the PCL language conversion unit 35, the PS language conversion unit 44, and the conversion language determining unit 43 according to the second embodiment of the present invention.

When the PAGES language analyzing unit 34 obtains the address of the receiver buffer 31 sent from the host device, i.e., the language determining unit 32, the PAGES language analyzing unit 34 determines whether the print data exists in the receiver buffer 31. When the print data exists, the PAGES language analyzing unit 34 retrieves the print data from the receiver buffer 31, and determines the language per one command according to the PAGES decode table 33.

For example, as shown in FIG. 10, the PAGES language analyzing unit 34 obtains “0x1b, 0x7e, 0x33, 0x00, 0x02, 0x01, 0x02” (representing a copy command in the PAGES format for specifying the number of copies and to be denoted as “ESX33” in PAGES command system) from the receiver buffer 31 as the print data. In the embodiment, two copies are specified. According to the PAGES decode table 33, the PAGES language analyzing unit 34 recognizes that “ESX33” is a command for performing a conversion process No. 5.

In the embodiment, the conversion language determining unit 43 selects the conversion language. As shown in FIG. 10, the PS format is set in the conversion language information 42a. Accordingly, when the conversion language determining unit 43 refers to the conversion language information 42a of the menu unit 42, the PS language converting unit 44 is selected. Note that a user of the printer 30 can freely change a setting of the conversion language information 42a through operating the operation unit 50 of the menu unit 42.

In order to convert the language per one command to the PS format, the conversion language determining unit 43 directs the PS language conversion unit 44 to perform the conversion process No. 5. Accordingly, the PS language conversion unit 44 performs the conversion process No. 5 directed by the conversion language determining unit 43 to convert the language to the PS format per one command.

As shown in FIG. 10, the PS language conversion unit 44 has a PS language conversion processing unit 44a. When the PS language conversion unit 44 is directed to perform the conversion process No. 5, the PS language conversion unit 44 calls the conversion process No. 5 from the PS language conversion processing unit 44a. In the conversion process No. 5, “<<Num Copies 2>> setpagedevice<cr><lf>” (specifying the number of copies in the PS format) is written in the post-conversion language store buffer 36. The PS language conversion unit 44 copies the command thus converted in the post-conversion store buffer 36.

Then, it is determined whether the PS language conversion unit 44 completes the conversion. When the PS language conversion unit 44 completes the conversion, the PS language conversion unit 44 sends the address of the post-conversion language store buffer 36 to the PS language analyzing unit 45. The PS language conversion unit 44 repeats the process until all of the print data in the receiver buffer 31 is processed. When all of the print data is processed, the PS language conversion unit 44 completes the process.

When the conversion language determining unit 43 refers to the conversion language information 42a of the menu unit 42 and the PCL format is set in the conversion language information 42a, the PCL language conversion unit 35 is selected. When the PCL language conversion unit 35 is selected, an operation is similar to that in the first embodiment, and explanation thereof is omitted.

The flow chart shown in FIG. 9 will be explained below. In Step S41, the PAGES language analyzing unit 34 obtains the address of the receiver buffer 31. In Step S42, the PAGES language analyzing unit 34 determines whether the print data exists in the receiver buffer 31. When the print data exists, the process proceeds to S43. When the print data does not exists, the process is completed.

In Step S43, the PAGES language analyzing unit 34 retrieves the print data from the receiver buffer 31. In Step S44, the PAGES language analyzing unit 34 recognizes the language per one command according to the PAGES decode table 33.

In Step S45, the conversion language determining unit 43 selects the language. When the conversion language determining unit 43 selects the PS format, the process proceeds to Step S46. When the conversion language determining unit 43 selects the PCL format, the process proceeds to Step S50.

In Step S46, the PS language conversion unit 44 converts the language to the PS format per one command. In Step S47, the PS language conversion unit 44 copies the command thus converted in the post-conversion language store buffer 36. In Step S48, the PS language conversion unit 44 determines whether the PS language conversion unit 44 completes the conversion. When the PS language conversion unit 44 completes the conversion, the process proceeds to Step S49. When the PS language conversion unit 44 does not complete the conversion, the process returns to Step S46.

In Step 49, the PS language conversion unit 44 sends the address of the post-conversion language store buffer 36 to the PS language analyzing unit 45, and the process returns to Step S42.

In Step S50, the PCL language conversion unit 35 converts the language to the PCL format per one command. In Step S51, the PCL language conversion unit 35 copies the command thus converted to the post-conversion language store buffer 36. In Step S52, the PCL language conversion unit 35 determines whether the PCL language conversion unit 35 completes the conversion. When the PCL language conversion unit 35 completes the conversion, the process proceeds to Step S53. When the PCL language conversion unit 35 does not complete the conversion, the process returns to Step S50.

In Step S53, the PCL language conversion unit 35 sends the address of the post-conversion language store buffer 36 to the PCL language analyzing unit 37, and the process returns to Step S42.

As described above, in the embodiment, the printer 30 includes the PS language conversion unit 44 for converting the PAGES format to the PCL format and the conversion language determining unit 43 in addition to the PCL language conversion unit 35 for converting the PAGES format to the PCL format. Therefore, the printer 30 can select whether the PAGES format is converted to the PCL format or the PS format. The PS format generally provides color space definition more various than that of the PCL format. Accordingly, for example, the printer 30 selects the PCL format when a faster printer speed is required. The printer 30 selects the PS format when printing quality is required. Accordingly, the printer 30 can select the page description language depending on a use, thereby improving utility of the printer 30.

In the embodiment, the printer 30 has the menu unit 42. Alternatively, the printer 30 may determine attribution of the print data. Accordingly, the printer 30 converts the print data to the PCL format when the print data is a text, and the printer 30 convert the print data to the PS format when the print data is a graphic.

In the embodiments, the invention is applied to the printer 30, and the invention is not limited thereto. The invention can be applied to a printing apparatus such as a facsimile, an MFP (multi-function printer), and a copy machine capable of processing a printer description language.

The disclosure of Japanese Patent Application No. 2006-175265, filed on Jun. 26, 2006 is incorporated in the application by reference.

While the invention has been explained with reference to the specific embodiments of the invention, the explanation is illustrative and the invention is limited only by the appended claims.

What is claimed is:

1. A printing apparatus comprising:
a language determining unit for determining whether print data is described in a first description language or a second description language;
a first language conversion unit for converting the print data described in the second description language to the print data described in the first description language when the language determining unit determines that the print data is described in the second description language; and
a first print control unit for analyzing the print data described in the first description language and printing on a recording medium.

2. The printing apparatus according to claim 1, wherein said first language conversion unit is adopted to convert the print data described in the second description language to the print data described in the first description language per one command.

3. The printing apparatus according to claim 1, wherein said first language conversion unit includes corresponding information of the first description language and the second description language.

4. The printing apparatus according to claim 1, wherein said language determining unit is adopted to analyze a command of the print data to determine whether the print data is described in the first description language or the second description language.

5. The printing apparatus according to claim 1, further comprising:
a second print control unit for analyzing the print data described in a third description language and printing on the recording medium;
a second language conversion unit for converting the print data described in the second description language to the print data described in the third description language; and
a conversion selection unit for selecting one of the first language conversion unit and the second language conversion unit when the language determining unit determines that the print data is described in the second description language so that the first print control unit prints on the recording medium when the conversion selection unit selects the first language conversion unit and the second print control unit prints on the recording medium when the conversion selection unit selects the second language conversion unit.

6. The printing apparatus according to claim 1, wherein said conversion selection unit includes an apparatus menu.

7. The printing apparatus according to claim 1, wherein said conversion selection unit is adopted to detect conversion selection information from a command of the print data.

8. The printing apparatus according to claim 1, wherein said conversion selection unit is adopted to select one of the first language conversion unit and the second language conversion unit according to attribution of the print data.

9. The printing apparatus according to claim 1, wherein said conversion selection unit is adopted to select one of the first language conversion unit and the second language conversion unit according to attribution of the print data indicating that the print data includes one of a text and a graphic.
